(19) United States
(12) Patent Application Publication
(10) Pub. No.: US 2025/0007681 A1
(43) Pub. Date: Jan. 2, 2025

(54) METHOD AND APPARATUS FOR HALF-DUPLEX-FREQUENCY DIVISION DUPLEX MODE SWITCH IN MOBILE COMMUNICATIONS

(71) Applicant: MEDIATEK INC., Hsinchu City (TW)

(72) Inventors: Hsuan-Li LIN, Hsinchu City (TW); Wei-Hsin SU, Hsinchu City (TW); Tsang-Wei YU, Hsinchu City (TW); Huan-Ren FU, Hsinchu City (TW)

(21) Appl. No.: 18/712,421

(22) PCT Filed: Dec. 5, 2022
(86) PCT No.: PCT/CN2022/136510

§ 371 Date: May 22, 2024

Related U.S. Application Data
(60) Provisional application No. 63/294,122, filed on Dec. 28, 2021.

(51) Int. Cl. H04L 5/16; H04W 52/02

(52) U.S. Cl. CPC H04L 5/16; H04W 52/0261

(57) ABSTRACT

Various solutions for half-duplex-frequency division duplex (HD-FDD) mode switch with respect to user equipment and network apparatus in mobile communications are described. An apparatus may report a capability of supporting full-duplex-frequency division duplex (FD-FDD) to a network node. The apparatus may receive a configuration from the network node configuring an operation mode. The apparatus may operate in an HD-FDD mode in an event that the configuration configures the HD-FDD mode. The apparatus may operate in an FD-FDD mode in an event that the configuration configures the FD-FDD mode.

### CROSS REFERENCE TO RELATED PATENT APPLICATION(S)

The present disclosure claims the priority benefit of U.S. Provisional Patent Application No. 63/294,122, filed on 28 Dec. 2021. The contents of aforementioned application are herein incorporated by reference in their entirety.

### TECHNICAL FIELD

The present disclosure is generally related to mobile communications and, more particularly, to half-duplex-frequency division duplex (HD-FDD) mode switch with respect to user equipment and network apparatus in mobile communications.

### BACKGROUND

Unless otherwise indicated herein, approaches described in this section are not prior art to the claims listed below and are not admitted as prior art by inclusion in this section.

In a wireless communication system, full-duplex operation is the optimal duplexing option where transmitting and receiving are simultaneously achieved by providing enough separation between transmitter and receiver antennas. In a Full-Duplex-Frequency Division Duplex (FD-FDD) system, the UE receiver and transmitter operate simultaneously on different frequencies. The different frequencies can provide the necessary separation between uplink and downlink signal paths. In contrast, half-duplex operation at a device allows time for the device to switch between transmission and reception modes. It does not allow bidirectional communication at the same time (i.e., simultaneous bidirectional communication) for the device. It can do transmission only at one time and do reception only at another time. Different carrier frequencies can be used for a Half-Duplex-Frequency Division Duplex (HD-FDD) system where uplink and downlink communications are not only on distinct frequencies but are also separated in the time domain.

Generally, the UE needs to prepare the FD-FDD operation with higher power consumption to support simultaneous receiving and transmitting performance compared to HD-FDD operation. However, in the HD-FDD operation, the UE may save a lot of energy by turning off transmitter or receiver when it is not used. It will waste UE power if the UE operates in the FD-FDD operation but the network node only deploys/operates in the HD-FDD operation.

Accordingly, how to properly reduce UE power consumption becomes an important issue for high frequency transmissions in the newly developed wireless communication network. Therefore, there is a need to provide proper schemes to switch the UE operation mode to the HD-FDD mode for power saving.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to HD-FDD mode switch with respect to user equipment and network apparatus in mobile communications.

In one aspect, a method may involve an apparatus reporting a capability of supporting FD-FDD to a network node. The method may also involve the apparatus receiving a configuration from the network node configuring an operation mode. The method may further involve the apparatus operating in an HD-FDD mode in an event that the configuration configures the HD-FDD mode. The method may further involve the apparatus operating in an FD-FDD mode in an event that the configuration configures the FD-FDD mode.

In one aspect, a method may involve an apparatus transmitting a request to switch an operation mode to a network node. The method may also involve the apparatus receiving a response from the network node configuring an operation mode. The method may further involve the apparatus operating in an HD-FDD mode or an FD-FDD mode according to the response.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising reporting, via the transceiver, a capability of supporting FD-FDD to the network node. The processor may also perform operations comprising receiving, via the transceiver, a configuration from the network node configuring an operation mode. The processor may further perform operations comprising operating in an HD-FDD mode in an event that the configuration configures the HD-FDD mode. The processor may further perform operations comprising operating in an FD-FDD mode in an event that the configuration configures the FD-FDD mode.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising transmitting, via the transceiver, a request to switch an operation mode to the network node. The processor may also perform operations comprising receiving, via the transceiver, a response from the network node configuring an operation mode. The processor may further perform operations comprising operating in an HD-FDD mode or an FD-FDD mode according to the response.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HD-FDD mode switch with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In a wireless communication system, full-duplex operation is the optimal duplexing option where transmitting and receiving are simultaneously achieved by providing enough separation between transmitter and receiver antennas. In an FD-FDD system, the UE receiver and transmitter operate simultaneously on different frequencies. The different frequencies can provide the necessary separation between uplink and downlink signal paths. In contrast, half-duplex operation at a device allows time for the device to switch between transmission and reception modes. It does not allow bidirectional communication at the same time (i.e., simultaneous bidirectional communication) for the device. It can do transmission only at one time and do reception only at another time. Different carrier frequencies can be used for an HD-FDD system where uplink and downlink communications are not only on distinct frequencies but are also separated in the time domain.

Generally, a UE with FD-FDD capability can be operated in the FD-FDD mode, where receiving and transmitting operations are concurrent, or in HD-FDD mode, where receiving and transmitting operations never occur simultaneously. However, in current NR system, when the UE supports FD-FDD functionality, the UE will be configured to operate in the FD-FDD mode all the time whereas the network node can dynamically schedule between FD-FDD mode HD-FDD mode. This will cause unnecessary waste on UE power consumption. The UE needs to prepare FD-FDD operation with higher power consumption to support simultaneous receiving and transmitting performance compared to HD-FDD operation. With HD-FDD, the UE may save a lot of energy by turning off transmitter or receiver when it is not used. It will waste UE power if the UE can support FD-FDD operation but the network node only deploys/operates in HD-FDD operation. Especially for reduced capability (RedCap) applications, most operators are using HD-FDD mode as baseline. The UE or RedCap devices will waste power to prepare for FD-FDD operation.

In view of the above, the present disclosure proposes several schemes pertaining to switching between FD-FDD mode and HD-FDD mode with respect to user equipment and network apparatus in mobile communications. According to the schemes of the present disclosure, some switching mechanisms and trigger conditions may be introduced to resolve the aforementioned UE power wasting issues. For switching between FD-FDD mode and HD-FDD mode, the network node and the UE need to communicate/align with each other on a current mode in use so that the UE can perform corresponding optimization. To avoid that the UE operates in the FD-FDD mode but the network node actually uses the HD-FDD mode, the UE should switch to the HD-FDD mode for lower battery consumption as much as possible for power saving. For example, the UE may switch its radio frequency (RF) front-end circuit to a week rejection filter (e.g., duplexer switches to a surface acoustic wave (SAW) filter) to reduce power consumption. Some parts of the RF front-end circuit can be turned-off in the HD-FDD mode. Thus, the UE is able to optimize its power performance by using higher power in FD-FDD mode for better performance and using lower power in HD-FDD mode for power saving. Accordingly, the UE power consumption can be well controlled and the RF performance can be refined for FD-FDD mode when FD-FDD mode is in use.

In general, the UE may indicate its capability on operation mode (e.g., FD-FDD mode or HD-FDD mode) to the network node. For the UE supporting the FD-FDD mode, the network node may further confirm which mode should be used. The network node may configure/activate/indicate a current operation mode (e.g., FD-FDD mode or HD-FDD mode) to the UE. The UE may determine and switch its operation mode based on the network configuration. Alternatively, the UE may also send a request on a preferred operation mode to the network node. The network node may further confirm whether the preferred operation mode can be used. The UE described in the present disclosure may comprise a RedCap UE, a power class 2 (PC2) UE or any other devices supporting lower power operation mode (e.g., power saving mode).

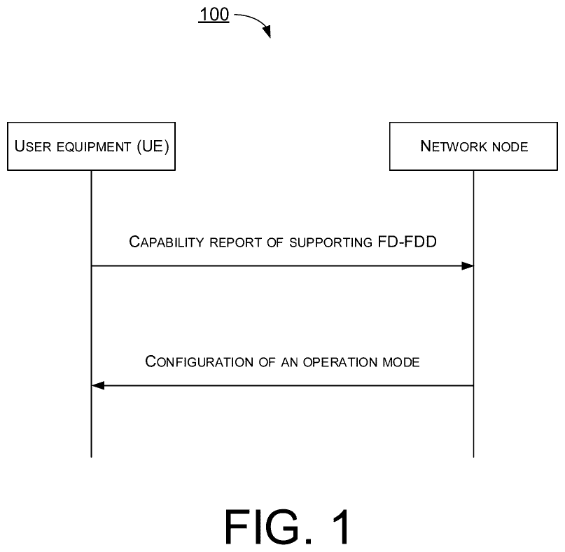

FIG. 1 illustrates an example scenario 100 under schemes in accordance with implementations of the present disclosure. Scenario 100 involves at least one UE and at least one network node, which may be a part of a wireless communication network (e.g., an LTE network, a 5G network, an NR network, an IoT network or a 6G network). The UE may be configured to transmit a capability report to indicate its operation mode capability to the network node. For example, the capability report may indicate that the UE has the capability for supporting the FD-FDD mode. The network node may be configured to configure/active/indicate the operation mode (e.g., HD-FDD mode or FD-FDD mode) to the UE. The network node may configure the operation mode per band or indicate the operation mode for the current band. The network node may determine the operation mode based on some conditions. For example, the network node may configure HD-FDD mode when determining that the uplink interference is lower than a threshold value.

The UE may be configured to receive the configuration from the network node configuring the operation mode. Then, the UE may need to prepare for the configured operation mode. In one scenario, the UE may prepare for and operate in the HD-FDD mode in an event that the HD-FDD mode is configured/activated/indicated. The UE may switch its RF front-end circuit to a lower power consumption mode when operating in the HD-FDD mode. For example, the UE may switch its RF front-end circuit or transceiver to lower insertion loss or weak rejection filter (e.g., the duplexer switches to surface acoustic wave (SAW) filter). In another scenario, the UE may prepare for and operate in the FD-FDD mode in an event that the FD-FDD mode is configured/activated/indicated. For example, the UE may switch its RF front-end circuit or transceiver to higher power consumption mode to optimize the performance when operating in the FD-FDD mode.

In some implementations, the network signaling may configure the operation mode per frequency band. For example, the UE may report the capability on support of the FD-FDD mode to the network node. The network node may configure the HD-FDD mode for band #0 and the FD-FDD mode for band #1 to the UE. The configuration may be carried in broadcast information (e.g., system information block) or in a radio resource control (RRC) signaling. Then, when the UE operates on band #0, the UE will prepare for the HD-FDD mode. When the UE operates on band #1, the UE will prepare for the FD-FDD mode.

In some implementations, the network signaling may configure the operation mode on the current frequency band. For example, the UE may report the capability on support of the FD-FDD mode to the network node. When band #1 is in use, the network node may indicate the HD-FDD mode for the current band in use to the UE. This information may be carried in a media access control-control element (MAC-CE), an RRC signaling or a SIB message. Then, the UE may apply the HD-FDD mode for the current band (e.g., band #1). Alternatively, the network node may indicate the FD-FDD mode for the current band in use to the UE. This information may be carried in a MAC-CE, an RRC signaling or a SIB message. Then, the UE may apply the FD-FDD mode for the current band (e.g., band #1).

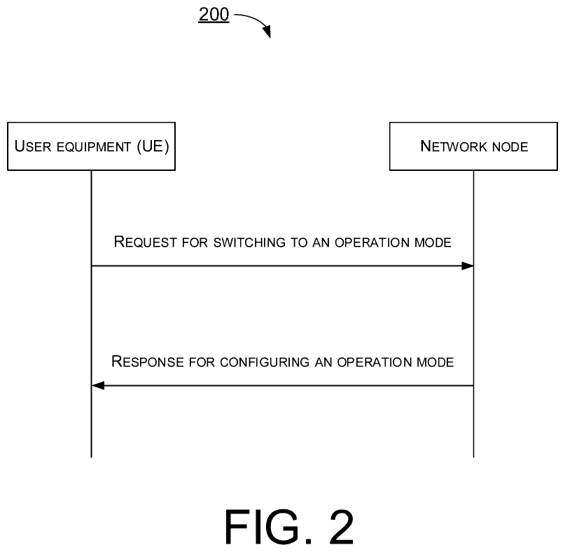

In another aspect, the switch of the operation mode may be initiated or triggered with UE assisted information (e.g., signaling from the UE to the network node). FIG. 2 illustrates an example scenario 200 under schemes in accordance with implementations of the present disclosure. Scenario 200 involves at least one UE and at least one network node, which may be a part of a wireless communication network (e.g., an LTE network, a 5G network, an NR network, an IoT network or a 6G network). The UE may transmit a request to switch an operation mode (e.g., HD-FDD mode or FD-FDD mode) to the network node. The UE may transmit such request based on some trigger conditions. For example, when the UE battery is lower than a threshold or the UE is operated in a power saving mode, the UE may switch to the HD-DD mode to extend the battery life. After transmitting the mode-switch request, the UE may receive a response from the network node configuring the operation mode. For example, the network node may acknowledge whether the request is enforced/executed. The network node may also indicate which operation mode (e.g., HD-FDD mode or FD-FDD mode) is in use. Then, the UE may prepare for and operate in the requested mode (e.g., HD-FDD mode or FD-FDD mode) according to the response.

In some implementations, the UE may operate in the FD-FDD mode in band #1. This can be configured by default/predefined or can be configured/activated/indicated by the abovementioned methods. The UE may transmit a request to indicate to switch to the HD-FDD mode on a specific frequency band. For example, the UE may transmit the request to apply the HD-FDD mode for band #1. Then, the UE may apply the HD-FDD mode for band #1 in an event that the UE receives network node's confirmation/acknowledgement or the network node indicates the HD-FDD mode or indicates an approval. Otherwise, the UE may apply the FD-FDD mode for band #1 in an event that the UE does not receive network node's confirmation/acknowledgement or the UE receives network node's rejection/negative acknowledgement or indication to use the FD-FDD mode.

### Illustrative Implementations

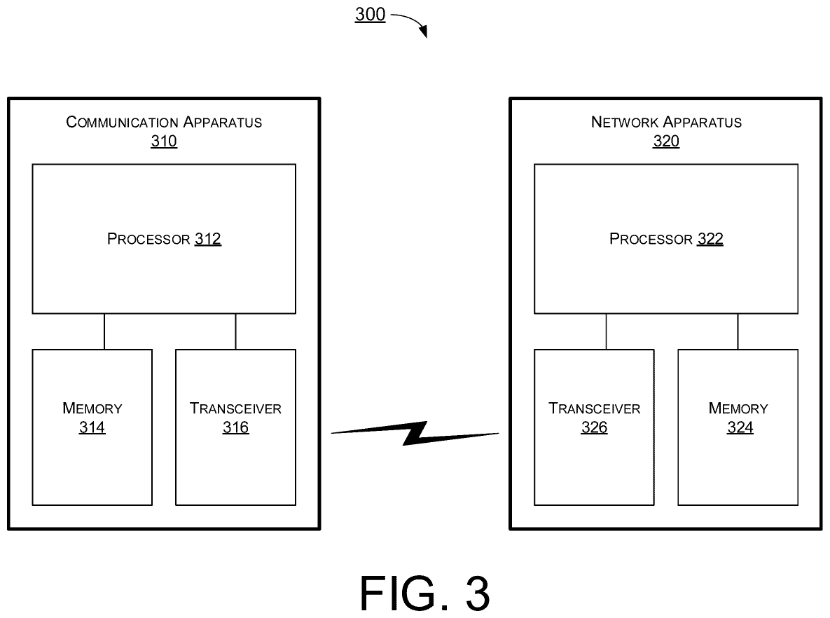

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to HD-FDD mode switch with respect to user equipment and network apparatus in mobile communications, including scenarios/schemes described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to report, via the transceiver 316, a capability of supporting FD-FDD to network apparatus 320. Then, processor 312 may be configured to receive, via the transceiver 316, a configuration from network apparatus 320 configuring an operation mode. Processor 312 may operate in the HD-FDD mode in an event that the configuration configures the HD-FDD mode. Processor 312 may operate in the FD-FDD mode in an event that the configuration configures the FD-FDD mode.

In some implementations, processor 322 may configure the operation mode per band or configure the operation mode for the current band.

In some implementations, processor 322 may configure the operation mode when the uplink interference is low.

In some implementations, processor 312 may switch transceiver 316 to a lower power consumption mode when operating in the HD-FDD mode, processor 312 may switch transceiver 316 to a higher power consumption mode when operating in the FD-FDD mode.

In some implementations, the communication apparatus 310 may be a RedCap UE or a PC2 UE.

In some implementations, processor 312 may be configured to transmit, via the transceiver 316, a request to switch the operation mode to network apparatus 320. Then, processor 312 may be configured to receive, via the transceiver 316, a response from network apparatus 320 configuring an operation mode. Processor 312 may operate in the HD-FDD mode or the FD-FDD mode according to the response.

In some implementations, processor 312 may indicate a request to switch to the HD-FDD mode on a specific frequency band.

In some implementations, processor 312 may operate in the HD-FDD mode in an event that the response comprises an acknowledgement or indicates the HD-FDD mode or an approval.

In some implementations, processor 312 may operate in the FD-FDD mode in an event that the response comprises a negative acknowledgement or indicates the FD-FDD mode or a rejection.

In some implementations, processor 312 may transmit the request in an event that a batter level of communication apparatus 310 is low or communication apparatus 310 is operated in a power saving mode.

### Illustrative Processes

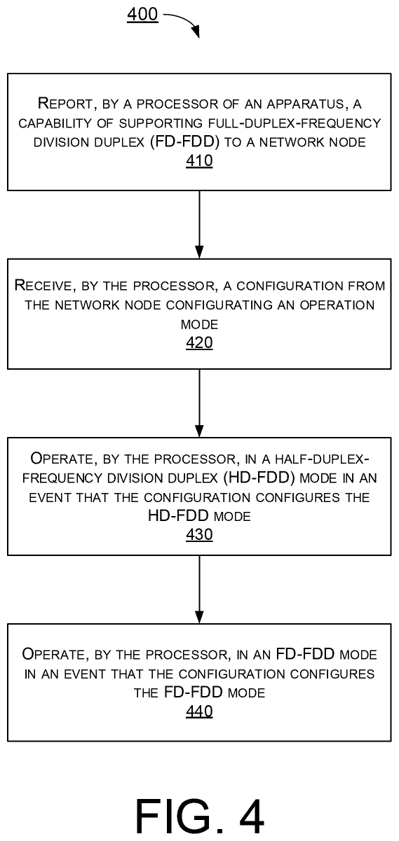

FIG. 4 illustrates an example process 400 in accordance with an implementation of the present disclosure. Process 400 may be an example implementation of above scenarios/schemes, whether partially or completely, with respect to HD-FDD mode switch with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 reporting, by a processor of an apparatus, a capability of supporting FD-FDD to a network node. Process 400 may proceed from 410 to 420.

At 420, process 400 may involve processor 312 receiving, by the processor, a configuration from the network node configuring an operation mode. Process 400 may proceed from 420 to 430.

At 430, process 400 may involve processor 312 operating, by the processor, in a HD-FDD mode in an event that the configuration configures the HD-FDD mode. Process 400 may proceed from 430 to 430.

At 440, process 400 may involve processor 312 operating, by the processor, in an FD-FDD mode in an event that the configuration configures the FD-FDD mode.

In some implementations, the operation mode is configured per band or configured for a current band. The HD-FDD mode is configured when uplink interference is low.

In some implementations, process 400 may involve processor 312 switching, by the processor, an RF front-end circuit to a lower power consumption mode when operating in the HD-FDD mode.

In some implementations, process 400 may involve processor 312 switching, by the processor, an RF front-end circuit to a higher power consumption mode when operating in the FD-FDD mode.

In some implementations, the apparatus may comprise a RedCap UE or a PC2 UE.

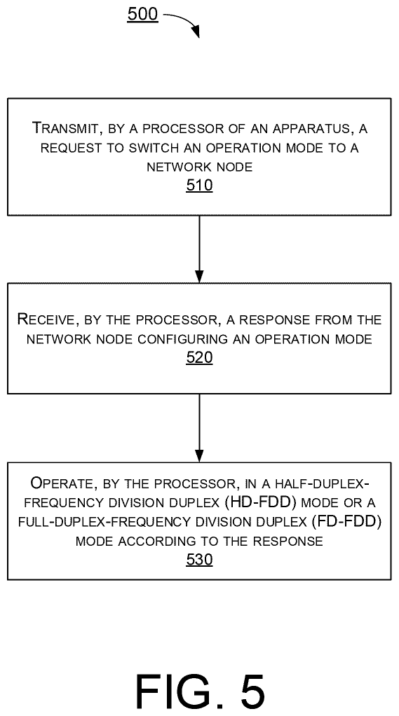

FIG. 5 illustrates an example process 500 in accordance with an implementation of the present disclosure. Process 500 may be an example implementation of above scenarios/schemes, whether partially or completely, with respect to HD-FDD mode switch with the present disclosure. Process 500 may represent an aspect of implementation of features of communication apparatus 310. Process 400 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of communication apparatus 310 transmitting, by a processor of an apparatus, a request to switch an operation mode to a network node. Process 500 may proceed from 510 to 520.

At 520, process 500 may involve processor 312 receiving, by the processor, a response from the network node configuring an operation mode. Process 500 may proceed from 520 to 530.

At 530, process 500 may involve processor 312 operating, by the processor, in an HD-FDD mode or an FD-FDD mode according to the response.

In some implementations, the request indicates to switch to the HD-FDD mode on a specific frequency band.

In some implementations, process 500 may involve processor 312 operating in the HD-FDD mode in an event that the response comprises an acknowledgement or indicates the HD-FDD mode or an approval.

In some implementations, process 500 may involve processor 312 operating in the FD-FDD mode in an event that the response comprises a negative acknowledgement or indicates the FD-FDD mode or a rejection.

In some implementations, process 500 may involve processor 312 transmitting the request in an event that a batter level is low or the apparatus is operated in a power saving mode.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
reporting, by a processor of an apparatus, a capability of supporting full-duplex-frequency division duplex (FD-FDD) to a network node;
receiving, by the processor, a configuration from the network node configuring an operation mode;
operating, by the processor, in a half-duplex-frequency division duplex (HD-FDD) mode in an event that the configuration configures the HD-FDD mode; and
operating, by the processor, in an FD-FDD mode in an event that the configuration configures the FD-FDD mode.

2. The method of claim 1, wherein the operation mode is configured per band or configured for a current band.

3. The method of claim 1, wherein the HD-FDD mode is configured when uplink interference is low.

4. The method of claim 1, further comprising:
switching, by the processor, a radio frequency (RF) front-end circuit to a lower power consumption mode when operating in the HD-FDD mode; and
switching, by the processor, the RF front-end circuit to a higher power consumption mode when operating in the FD-FDD mode.

5. The method of claim 1, wherein the apparatus comprises a reduced capability (RedCap) user equipment (UE) or a power class 2 (PC2) UE.

6. A method, comprising:
transmitting, by a processor of an apparatus, a request to switch an operation mode to a network node;
receiving, by the processor, a response from the network node configuring an operation mode; and
operating, by the processor, in a half-duplex-frequency division duplex (HD-FDD) mode or a full-duplex-frequency division duplex (FD-FDD) mode according to the response.

7. The method of claim 6, wherein the request indicates to switch to the HD-FDD mode on a specific frequency band.

8. The method of claim 6, wherein the operating comprises operating in the HD-FDD mode in an event that the response comprises an acknowledgement or indicates the HD-FDD mode or an approval.

9. The method of claim 6, wherein the operating comprises operating in the FD-FDD mode in an event that the response comprises a negative acknowledgement or indicates the FD-FDD mode or a rejection.

10. The method of claim 6, wherein the transmitting comprises transmitting the request in an event that a batter level is low or the apparatus is operated in a power saving mode.

11. An apparatus, comprising:
a transceiver which, during operation, wirelessly communicates with at least one network node of a wireless network; and
a processor communicatively coupled to the transceiver such that, during operation, the processor performs operations comprising:
reporting, via the transceiver, a capability of supporting full-duplex-frequency division duplex (FD-FDD) to the network node;
receiving, via the transceiver, a configuration from the network node configuring an operation mode;
operating in a half-duplex-frequency division duplex (HD-FDD) mode in an event that the configuration configures the HD-FDD mode; and
operating in an FD-FDD mode in an event that the configuration configures the FD-FDD mode.

12. The apparatus of claim 11, wherein the operation mode is configured per band or configured for a current band.

13. The apparatus of claim 11, wherein the HD-FDD mode is configured when uplink interference is low.

14. The apparatus of claim 11, wherein, during operation, the processor further performs operations comprising:
switching the transceiver to a lower power consumption mode when operating in the HD-FDD mode; and
switching the transceiver to a higher power consumption mode when operating in the FD-FDD mode.

15. The apparatus of claim 11, wherein the apparatus comprises a reduced capability (RedCap) user equipment (UE) or a power class 2 (PC2) UE.

16-20. (canceled)
